(19) United States
(12) Patent Application Publication
(10) Pub. No.: US 2020/0074587 A1
(43) Pub. Date: Mar. 5, 2020

(54) Method and Apparatus for Mapping Virtual-Reality Image to a Segmented Sphere Projection Format

(71) Applicant: MEDIATEK INC., Hsinchu City (TW)

(72) Inventors: Ya-Hsuan LEE, Hsinchu City (TW); Jian-Liang LIN, Hsinchu City (TW); Shen-Kai CHANG, Hsinchu City (TW)

(21) Appl. No.: 16/607,505

(22) PCT Filed: Apr. 20, 2018
(86) PCT No.: PCT/CN2018/083825

§ 371 Date: Oct. 23, 2019

Related U.S. Application Data
(60) Provisional application No. 62/490,647, filed on Apr. 27, 2017.

(51) Int. Cl. G06T 3/00

(52) U.S. Cl. CPC G06T 3/0043; G06T 3/005

(57) ABSTRACT

Methods and apparatus of processing spherical images related to segmented sphere projection (SSP) are disclosed. According to one method, a North Pole region of the spherical image is projected to a first circular image and a South Pole region of the spherical image is projected to a second circular image using a mapping process selected from a mapping group comprising equal-area mapping, non-uniform mapping and cubemap mapping. Methods and apparatus of processing spherical images related to rotated sphere projection (RSP) are also disclosed. According to this method, the spherical image is projected into a first part of rotated sphere projection corresponding to a θ×φ region of the spherical image and a second part of rotated sphere projection corresponding to a remaining part of the spherical image using equal-area mapping.

### CROSS REFERENCE TO RELATED APPLICATIONS

The present invention claims priority to U.S. Provisional Patent Application, Ser. No. 62/490,647, filed on Apr. 27, 2017. The U.S. Provisional Patent Application is hereby incorporated by reference in its entirety.

### FIELD OF THE INVENTION

The present invention relates to 360-degree virtual reality image. In particular, the present invention relates to mapping a 360-degree virtual reality image into a segmented sphere projection (SSP) format, rotated sphere projection (RSP) format or modified cubemap projection (CMP) format.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a panoramic camera or a set of cameras arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree virtual reality (VR) images may be captured using a 360-degree spherical panoramic camera or multiple images arranged to cover all filed of views around 360 degrees. The three-dimensional (3D) spherical image is difficult to process or store using the conventional image/video processing devices. Therefore, the 360-degree VR images are often converted to a two-dimensional (2D) format using a 3D-to-2D projection method. For example, equirectangular (ERP) and cubic projection have been commonly used projection methods. For the ERP projection, the areas in the north and south poles of the sphere are stretched more severely (i.e., from a single point to a line) than areas near the equator. Furthermore, due to distortions introduced by the stretching, especially near the two poles, predictive coding tools often fail to make good prediction, causing reduction in coding efficiency.

To overcome the extreme distortion at north and south poles associated with the ERP format, segmented sphere projection (SSP) has been disclosed in JVET-E0025 (Zhang et al., “AHG8: Segmented Sphere Projection for 360-degree video”, Joint Video Exploration Team (WET) of ITU-T SG 16 WP 3 and ISO/IEC JTC 1/SC 29/WG 11, 5th Meeting: Geneva, CH, 12-20 Jan. 2017, Document: WET-E0025) as a method to convert a spherical image into an SSP format. FIG. 1A illustrates an example of segmented sphere projection, where a spherical image 100 is mapped into a North Pole image 110, a South Pole image 120 and an equatorial segment image 130. The boundaries of 3 segments correspond to latitudes 45° N (102) and 45° S (106), where 0° corresponds to the equator. The North and South Poles are mapped into 2 circular areas (110 and 120), and the projection of the equatorial segment is the same as ERP. The diameter of the circle is equal to the width of the equatorial segments because both Pole segments and equatorial segment have a 90° latitude span.

The layout 150 is vertically transposed for the sake of a smaller line buffer (i.e., narrower image width) as shown in FIG. 1B. A rectangular area 140 is added around the circular images 110 and 120. The rectangular area 140 can also be viewed as two square areas, each enclosing a circular area (i.e., 110 or 120). The redundant area, also referred as a void area in this disclosure, is shown as dots-filled background. The projection formulas are listed in equations (1) and (2) below, where the top part of equation (1) corresponds to the projection to the North Pole image 110 (i.e., θ′ϵ(π/4, π/2]) and the lower part of equation (1) corresponds to the projection to the South Pole image 120 (i.e., θ′ϵ[−π/2, −π/4)). Equation (2) corresponds to the projection of the equatorial segment 130 (i.e., θ′ϵ[−π/4, π/4]). Equation (1) indicates how to map a point on the cap (θ′, ϕ) into a point (x′, y′) in the circular areas. Equation (2) uses the same projection as Equirectangular Projection (ERP) to convert the equator area into the rectangle. The coordinate system (θ′, ϕ) is indicated in FIG. 1A.

$$\begin{matrix}\{ \begin{matrix}\begin{matrix}{x}^{′} = \frac{w}{2} ( 1 + \frac{( \frac{π}{2} - {θ}^{′} ) sin φ}{\frac{π}{4}} ) - 0.5 , \\ {y}^{′} = \frac{w}{2} ( 1 + \frac{( \frac{π}{2} - {θ}^{′} ) cos φ}{\frac{π}{4}} ) - 0.5\end{matrix} & {θ}^{′} ∈ ( \frac{π}{4} , \frac{π}{2} ] , φ ∈ ( - π , π ] \\ \begin{matrix}{x}^{′} = \frac{w}{2} ( 1 + \frac{( \frac{π}{2} - {θ}^{′} ) sin φ}{\frac{π}{4}} ) - 0.5 , \\ {y}^{′} = \frac{w}{2} ( 1 + \frac{( \frac{π}{2} + {θ}^{′} ) sin φ}{\frac{π}{4}} ) - 0.5\end{matrix} & {θ}^{′} ∈ [ - \frac{π}{2} , - \frac{π}{4} ] , φ ∈ ( - π , π ]\end{matrix} & ( 1 a ) \\ \{ \begin{matrix}h = 4 w & \\ {x}^{′} = \frac{w}{2} - \frac{2 {θ}^{′}}{π} w - 0.5 , & {θ}^{′} ∈ [ - \frac{π}{4} , \frac{π}{4} ] \\ {y}^{′} = \frac{φ}{2 π} h + \frac{h}{2} - 0.5 , & φ ∈ ( - π , π ]\end{matrix} & ( 1 b )\end{matrix}$$

In JVET-F0052 (Lee et al., “AHG 8: EAP-based segmented sphere projection with padding”, Joint Video Exploration Team (JVET) of ITU-T SG 16 WP 3 and ISO/IEC JTC 1/SC 29/WG 11, 6th Meeting: Hobart, AU, 31 March-7 Apr. 2017, Document: JVET-F0052), an EAP-based segmented sphere projection (SSP) with padding is disclosed. According to JVET-F0052, the projection format of the equatorial segment is changed from ERP (equirectangular projection) to EAP (equal-area projection), which results in smoother and consistent image quality in terms of signal-to-noise over the whole latitude range.

In FIG. 1, the height h of the equatorial segment is equal to four times of the width w (i.e., h=4w). In other words, the rectangular area 130 can be divided into 4 squares, labelled as f=2, 3, 4 and 5. The forward (i.e., 3D to 2D) SSP mapping the middle equator to the segmented rectangle is according to the following equations:

$$\begin{matrix}{x}^{′} = \frac{w}{2} ( 1 - \frac{sin {θ}^{′}}{sin ( \frac{π}{4} )} ) - 0.5 & ( 2 a ) \\ {y}^{′} = \frac{2 φ}{π} w + ( 4 - f ) w - 0.5 & ( 2 b )\end{matrix}$$

The inverse (i.e., 2D to 3D) SSP mapping the segmented rectangle back to the middle equator is according the following equations:

$$\begin{matrix}φ = ( \frac{{y}^{′} + 0.5}{w} + f - 4 ) \cdot \frac{π}{2} & ( 3 a ) \\ {θ}^{′} = {sin}^{- 1} ( ( 0.5 - \frac{{x}^{′} + 0.5}{w} ) \cdot 2 sin ( \frac{π}{4} ) ) & ( 3 b )\end{matrix}$$

The SSP methods disclosed in JVET-E0025 and JVET-F0052 have been shown to produce better performance in terms of coding efficiency than ERP for video coding. However, the mapping for the North Pole and South Pole images for SSP may not be optimal. There may be other mapping that could result in better performance. Furthermore, there are some redundant areas (i.e., the void areas) around the circular images, which may cause negative impact on coding performance. In addition, there are boundaries between different segments in the SSP. Therefore, it is desirable to develop techniques to improve coding efficiency for the SSP.

In the present invention, similar issues also exist in rotated sphere projection (RSP) and cubemap projection (CMP). Therefore, improved method for RSP and CMP are also disclosed.

### BRIEF SUMMARY OF THE INVENTION

Methods and apparatus of processing spherical images related to segmented sphere projection (SSP) are disclosed. According to one method, a North Pole region of the spherical image is projected to a first circular image and a South Pole region of the spherical image is projected to a second circular image using a mapping process selected from a mapping group comprising equal-area mapping, non-uniform mapping and cubemap mapping. An equator region of the spherical image is projected to a rectangular image. A first square image and a second square image are derived from the first circular image and the second circular image respectively. The first square image, the second square image and the rectangular image are assembled into a rectangular layout format, and the spherical image in the rectangular layout format is provided for further processing.

In one embodiment, the first circular image and the second circular image are projected into the first square image and the second square image respectively using FG-Squircular mapping, simple stretching, elliptical grid mapping or Schwarz-Christoffel mapping.

In one embodiment, the rectangular layout format corresponds to the first square image and the second square image on separate ends of the rectangular image placed in a horizontal direction, the first square image and the second square image on separate ends of the rectangular image placed in a vertical direction, the first square image and the second square image stacked vertically with the rectangular image distorted and butted in a horizontal direction, or the first square image and the second square image stacked horizontally with the rectangular image distorted and butted in a vertical direction.

In one embodiment, the spherical image in the rectangular layout format is partitioned into slices or titles based on one or more discontinuous edges. A loop-filter process is disabled across any partition boundary. In another embodiment, data padding is applied to any void area between the first circular image and a first enclosing square, between the second circular image and a second enclosing square, or between both the first circular image and the second circular image and a third enclosing rectangle.

Methods and apparatus of processing spherical images related to inverse segmented sphere projection (SSP) are also disclosed. The process corresponds to the reverse process of spherical images to segmented sphere projection.

Methods and apparatus of processing spherical images related to rotated sphere projection (RSP) are disclosed. According to this method, the spherical image is projected into a first part of rotated sphere projection corresponding to a θ×φ region of the spherical image and a second part of rotated sphere projection corresponding to a remaining part of the spherical image using equal-area mapping, wherein θ corresponds to a longitude range covered by the first part of rotated sphere projection and φ corresponds to a latitude range covered by the first part of rotated sphere projection. The first part of rotated sphere projection and the second part of rotated sphere projection, or a modified first part of rotated sphere projection and a modified second part of rotated sphere projection are assembled into a rectangular layout format. The spherical image in the rectangular layout format is provided for further processing.

In one embodiment, the modified first part of rotated sphere projection is generated by stretching a top side and a bottom side of the first part of rotated sphere projection to form horizontal boundaries on the top side and the bottom side of the modified first part of rotated sphere projection and the modified second part of rotated sphere projection is generated by stretching a top side and a bottom side of the second part of rotated sphere projection to form horizontal boundaries on the top side and the bottom side of the modified second part of rotated sphere projection.

In one embodiment, the modified first part of rotated sphere projection is generated by applying projection to map the first part of rotated sphere projection into a first rectangular area and the modified second part of rotated sphere projection is generated by applying projection to map the second part of rotated sphere projection into a second rectangular area, wherein the projection is selected from a mapping group comprising FG-squircular mapping, simple stretching, elliptical grid mapping, Schwarz-Christoffel mapping. Padding can be applied around edge or boundary of the first part of rotated sphere projection, the modified first part of rotated sphere projection, the second part of rotated sphere projection, and the modified second part of rotated sphere projection or the rectangular layout format. For example, the padding is selected from a padding group comprising geometry mapping, spreading a boundary value and duplicating other sides to a padding region.

Methods and apparatus of processing spherical images related to inverse rotated sphere projection (RSP) are also disclosed. The process corresponds to the reverse process of spherical images to rotated sphere projection.

Methods and apparatus of processing spherical images by projecting each spherical image into one two-dimensional picture using 3D (three-dimension) to 2D (two-dimension) mapping are disclosed. According to one method, a spherical image sequence is received, where each spherical image corresponds to one 360-degree virtual reality image. Each spherical image is projected into one picture consisting of multiple two-dimensional images using three-dimension (3D three-dimension) to 2D (two-dimension) mapping. Each picture is divided into multiple partitions according to discontinuous edges of the multiple two-dimensional images associated with each picture. Video coding is then applied to two-dimensional images generated from the spherical image sequence having a same partition.

In the above method, the three-dimension (3D three-dimension) to 2D (two-dimension) mapping may be selected from a group comprising segmented sphere projection (SSP), rotated sphere projection (RSP) and cubemap projection (CMP). Each partition may correspond to one partitioned into one slice or one title. A loop-filter process related to the video coding may be disabled across any partition boundary.

Methods and apparatus of processing spherical images by projecting each two-dimensional picture into one spherical image using 2D (two-dimension) to 3D (three-dimension) mapping are also disclosed. The process corresponds to the reverse process of the above method.

### BRIEF DESCRIPTION OF THE DRAWINGS

FIG. 1A illustrates an example of segmented sphere projection, where a spherical image is mapped into a North Pole image, a South Pole image and an equatorial segment image.

FIG. 1B illustrates an example of layout for segmented sphere projection, where rectangular image is vertically transposed for the sake of a smaller line buffer (i.e., narrower image width).

FIG. 2A illustrates an example of mapping latitude φ between θ and π/2 to a ring 210 with radius d in the circular area to generate the North Pole image according to equal-angular projection.

FIG. 2B illustrates an example of mapping latitude φ between −θ and −π/2 to a ring with radius d in the circular area to generate the South Pole image according to equal-angular projection.

FIG. 3A illustrates an example of mapping latitude φ between θ and π/2 to a ring 210 with radius d in the circular area to generate the North Pole image according to equal-area projection.

FIG. 3B illustrates an example of mapping latitude φ between −θ and −π/2 to a ring with radius d in the circular area to generate the South Pole image according to equal-area projection.

FIG. 4A illustrates an example of mapping a unit sphere in 3D domain to a unit circular area centered at the origin (0, 0) represents the region of latitude θ to π/2.

FIG. 4B illustrates an example of mapping a unit sphere in 3D domain to a unit circular area centered at the origin (0, 0) represents the region of latitude −θ to −π/2.

FIG. 5 illustrates an example of the North Pole image generated using a power function as the non-uniform mapping.

FIG. 6 illustrates an example of a North Pole image generated using the cubemap projection.

FIG. 7 illustrates various SSP layouts for the two circular images and one rectangular image according to embodiments of the present invention.

FIG. 8 illustrates examples of discontinuous boundaries (shown as dashed lines) for various SSP layouts.

FIG. 9A illustrates an example of mapping circles in a circular area into squares in a square area according to the simple stretching.

FIG. 9B illustrates an example of mapping the North Pole image and the South Pole image to square images and respectively according to the simple stretching.

FIG. 10A illustrates an example of mapping a circular area into a square area according to the FG-squircular mapping.

FIG. 10B illustrates an example of mapping the North Pole image and the South Pole image to square images and respectively according to the FG-squircular mapping.

FIG. 11A illustrates an example of mapping a circular area into a square area according to the elliptical grid mapping.

FIG. 11B illustrates an example of mapping the North Pole image and the South Pole image to square images and respectively according to the elliptical grid mapping.

FIG. 12 illustrates an example of mapping a circular area into a square area according to the Schwarz-Christoffel mapping.

FIG. 13 illustrates an example of RSP, where the sphere is partitioned into a middle 270°×90° region and a residual part. These two parts of RSP can be further stretched on the top side and the bottom side to generate deformed parts having a horizontal boundary on the top and bottom.

FIG. 14 illustrates an example of RSP where the sphere is partitioned into a middle θ×φ region, and a residual part of RSP.

FIG. 15 illustrates an example of deforming each of the two-part faces into a rectangular shape using various mappings.

FIG. 16 illustrates examples of padding of original segmented faces and modified segmented faces for different layouts.

FIG. 17 illustrates examples of partition boundaries for RSP and modified RSP layouts.

FIG. 18 illustrates an example of the cubemap projection, where the coordinates of a sphere is shown. An ERP image for the cubemap projection consists of X-front, X-back, Z-front, Z-back, Y-top and Y-bottom.

FIG. 19 illustrates an example of the cubemap projection according to one embodiment of the present invention, where the six faces are divided to two modified groups, and each of the modified groups can be further resampled to a rectangle by dividing the latitude direction and the longitude direction equally.

FIG. 20 illustrates examples of padding of two-group faces and modified two-group faces for different layouts of cubemap projection.

FIG. 21 illustrates examples of partition boundary for two-group faces and modified two-group faces of cubemap projection.

FIG. 22 illustrates an exemplary flowchart of a system that processes spherical images related to segmented sphere projection (SSP) according to an embodiment of the present invention.

FIG. 23 illustrates an exemplary flowchart of a system that processes spherical images related to inverse segmented sphere projection (SSP) according to an embodiment of the present invention.

FIG. 24 illustrates an exemplary flowchart of a system that processes spherical images related to rotated sphere projection (RSP) according to an embodiment of the present invention.

FIG. 25 illustrates an exemplary flowchart of a system that processes spherical images related to inverse rotated sphere projection (RSP) according to an embodiment of the present invention.

FIG. 26 illustrates an exemplary flowchart of a system that processes spherical images by projecting each spherical image into one two-dimensional picture using 3D (three-dimension) to 2D (two-dimension) mapping according to an embodiment of the present invention, where each picture is divided into multiple partitions according to discontinuous edges.

FIG. 27 illustrates an exemplary flowchart of a system that processes spherical images by projecting each two-dimensional picture into one spherical image using 2D (two-dimension) to 3D (three-dimension) mapping according to an embodiment of the present invention, where each picture is divided into multiple partitions according to discontinuous edges.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Segmented Sphere Projection (SSP)

In the present invention, various technical areas to improve the coding efficiency related to SSP, including projection methods for mapping North and South Poles of the sphere to circular areas, layouts of the two Pole images and the rectangular segment, and mapping methods to map the circular areas to square areas, are disclosed.

Projection Methods for Mapping North and South Poles to Circular Areas

As mentioned earlier, in JVET-E0025, the North Pole image is generated according to the top part of equation (1) and the South Pole image is generated according to the lower part of equation (1). In the present invention, various other projects to generate the North Pole image and the South Pole image are disclosed.

A. Equal-Angular Projection for the Circular Area in SSP

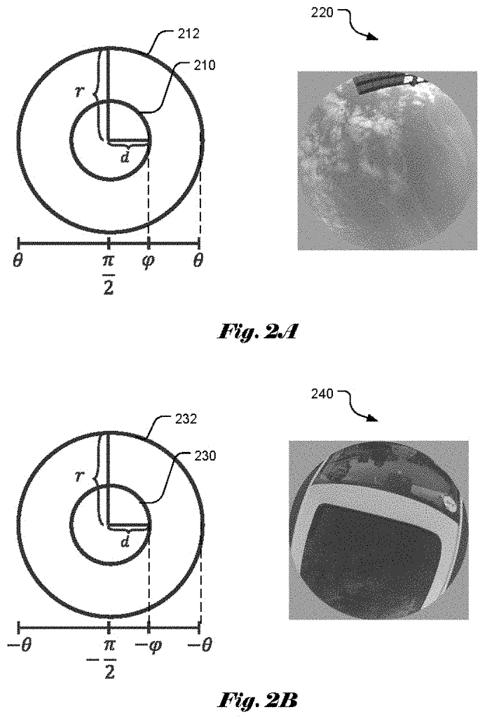

The SSP according to NET-E0025 belongs to this category. In an equal-angular projection format, pixel sampling divides latitude and longitude equally. A different representation of equal-angular projection is illustrated in the following. Assuming that a circular area 212 (i.e., a disk) with radius r represents the region of latitude from θ to π/2, then latitude φ between θ and π/2 is mapped to a ring 210 with radius d in the circular area 212 as shown in FIG. 2A according to the following equation:

d=[(π/2−φ/(π/2−θ]r (4a)

After radius d is determined, the coordinate for a point in the ring can be determined according to x′=w/2+d sin ϕ and y′=w/2 d cos ϕ. In other words, if the ring corresponding to latitude φ can be determined, the (x′,y′) location in the circular area can be determined. In FIG. 2A, an example of North Pole image 220 generated according to equal-angular projection is shown. Assuming that a disk 232 with radius r represents the region of latitude −θ to −π/2, then latitude (−φ) is mapped to a ring 230 with radius d as shown in FIG. 2B according to the following equation:

d=[(π/2+(−φ))/(π/2+(−θ))]r (4b)

In FIG. 2B, an example of South Pole image 240 generated according to equal-angular projection is shown. In the above alternative representation of the equal-angular projection, the North Pole and South Pole images correspond to θ equal to π/4.

B. Equal-Area Projection for the Circular in SSP

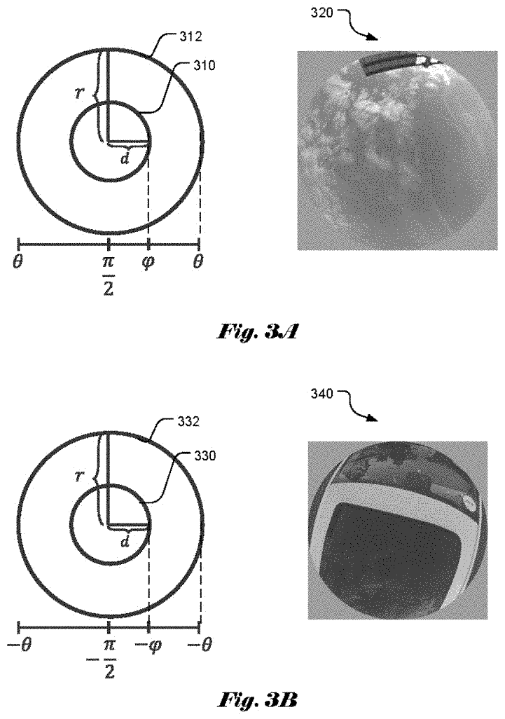

In an equal-area projection format, the sampling rate is proportional to the area on the sphere domain. This equal-area feature should be useful from image/video compression point of view since the coding artefact will presumably be uniform in all areas in the North Pole and South Pole images. Assuming that a circle with radius r represents the region of latitude θ to π/2, then latitude φ is mapped to a ring 310 with radius d in the circular area 312 as shown in FIG. 3A according to the following equation:

$$d = \frac{\sqrt{1 - sin ϕ}}{\sqrt{1 - sin θ}} r . \qquad ( 5 )$$

Again, after radius d is determined, the coordinate for a point in the ring can be determined according to x′=w/2+d sin ϕ and y′=w/2+d cos ϕ. In FIG. 3A, an example of North Pole image 320 generated according to equal-area projection is shown. Assuming that a circular area 332 with radius r represents the region of latitude −θ to −π/2, then latitude −φ is mapped to a ring 330 with radius d as shown in FIG. 3B according to the following equation:

$$d = \frac{\sqrt{1 + sin ( - ϕ )}}{\sqrt{1 + sin ( - θ )}} r . \qquad ( 6 )$$

In FIG. 3B, an example of South Pole image 340 generated according to equal-area projection is shown.

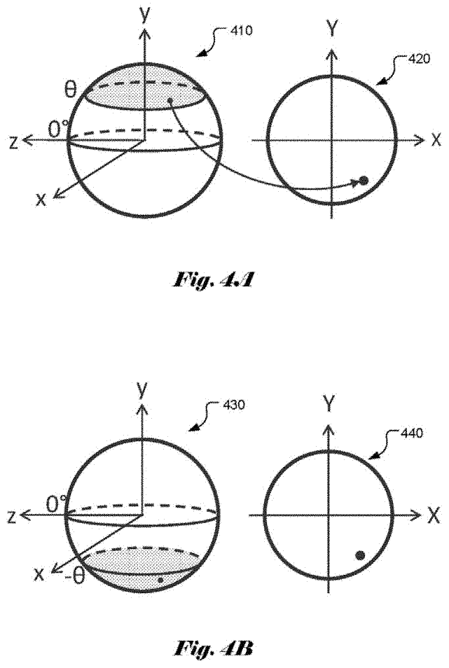

Since the sampling rate according to the equal-area projection format is proportional to the area on the sphere domain, Lambert azimuthal equal-area projection can be applied. Assuming that a unit circular area 420 centered at the origin (0, 0) represents the region of latitude θ to π/2, then for a unit sphere 410 in 3D domain, the 2D (X, Y) to 3D (x, y, z) conversion is as shown in FIG. 4A according to the following equation:

$$\begin{matrix}( u , v ) = ( \sqrt{2 - 2 cos ( \frac{π}{2} - θ )} X , \sqrt{2 - 2 cos ( \frac{π}{2} - θ )} Y ) & ( 7 ) \\ ( x , y , z ) = ( \sqrt{1 - \frac{{u}^{2} + {v}^{2}}{4}} u , 1 - \frac{{u}^{2} + {v}^{2}}{2} , \sqrt{1 - \frac{{u}^{2} + {v}^{2}}{4} v} ) & ( 8 )\end{matrix}$$

The 3D to 2D conversion is:

$$( X , Y ) = ( \frac{\sqrt{1 + sin θ}}{\sqrt{2} cos θ} \sqrt{\frac{2}{1 + y}} x , \frac{\sqrt{1 + sin θ}}{\sqrt{2} cos θ} \sqrt{\frac{2}{1 + y}} z ) \qquad ( 5 )$$

Assuming that a unit disk 440 centered at the origin (0, 0) represents the region of latitude −θ to −π/2, then for a unit sphere 430 in 3D domain, the 2D (X, Y) to 3D (x, y, z) conversion is as shown in FIG. 4B according to the following equation:

$$\begin{matrix}( u , v ) = ( \sqrt{2 - 2 cos ( \frac{π}{2} + ( - θ ) )} X , \sqrt{2 - 2 cos ( \frac{π}{2} + ( - θ ) )} Y ) & ( 10 ) \\ ( x , y , z ) = ( \sqrt{1 - \frac{{u}^{2} {v}^{2}}{4}} u , \frac{{u}^{2} + {v}^{2}}{2} - 1 , \sqrt{1 - \frac{{u}^{2} + {v}^{2}}{4}} v ) & ( 11 )\end{matrix}$$

The 3D to 2D conversion is:

$$( X , Y ) = ( \frac{\sqrt{1 - sin ( - θ )}}{\sqrt{2} cos ( - θ )} \sqrt{\frac{2}{1 - y}} x , \frac{\sqrt{1 - sin ( - θ )}}{\sqrt{2} cos ( - θ )} \sqrt{\frac{2}{1 - y}} z ) \qquad ( 12 )$$

C. Non-Uniform Mapping for the Circular Area in SSP

Non-uniform resampling can also be applied on the circular area to adjust the sampling rate. There are various non-uniform sampling techniques known in the field that can be used for non-uniform resampling. For example, the non-uniform resampling may correspond to:
piecewise linear function
exponential function
polynomial function
power function
any function or equation

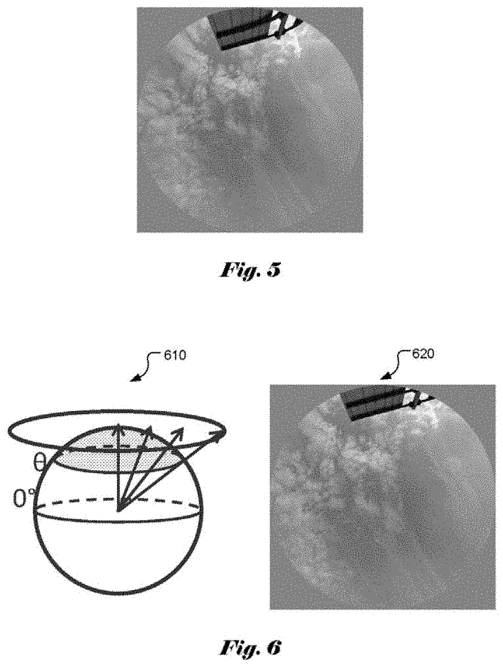

FIG. 5 illustrates an example of the North Pole image generated using a power function as the non-uniform mapping.

D. Cubemap Projection for the Circular Area in SSP

Cubemap layout is a well-known technique for a 2D representation of a 360-degree VR image by projecting a spherical image onto six faces of a cube. Cubemap projection can be applied to project the North or the South Pole image to a circular area. FIG. 6 illustrates an example of a North Pole image 620 generated using the cubemap projection 610.

Layout for Segmented Sphere Projection

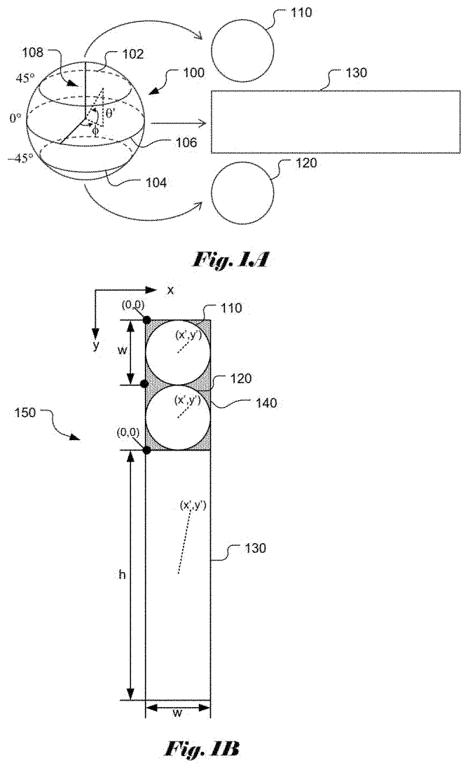

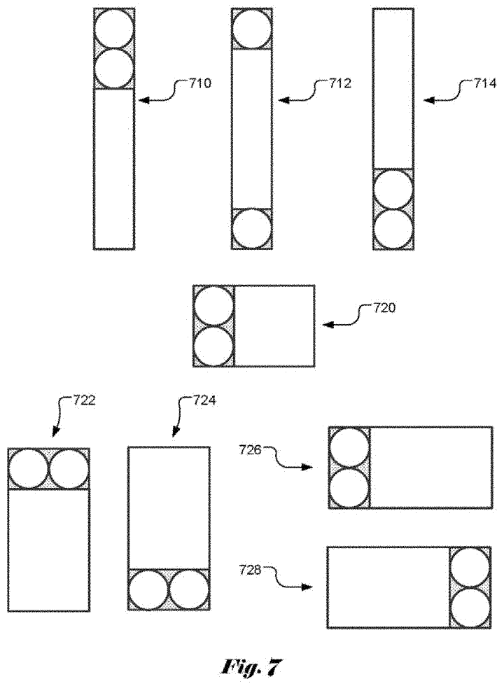

According to WET-E0025, the SSP layout corresponds to a strip with narrow width. In particular, the two disks are staggered on the top of the rectangular segment corresponding to the equatorial segment as shown in FIG. 1B. In the present invention, various SSP layouts for the two circular images and one rectangular image are disclosed as shown in FIG. 7. In FIG. 7, three vertical strip layouts corresponding to two circular images on the top (710), one circular image on each end (712) and two circular images at the bottom (714) are shown. Also, the rectangular image can be shrunk or stretched and then connected to the two circular images. Various layouts with shrunk or stretched rectangular area are shown in layouts 720-728.

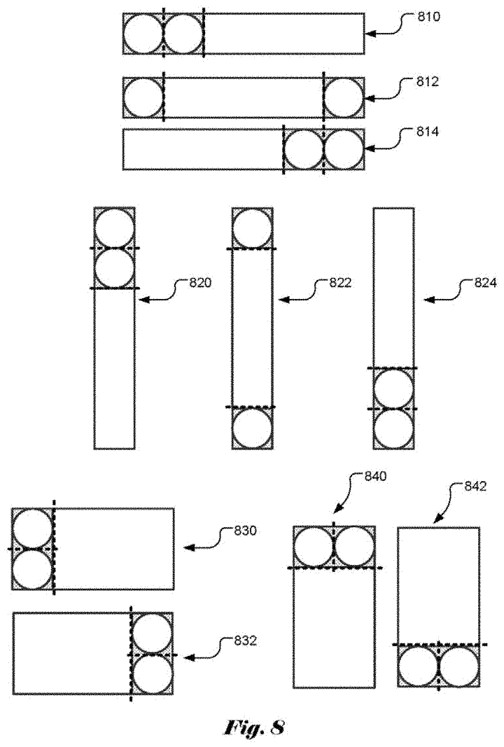

The picture can be divided into partitions such as slices, tiles, etc., according to the discontinuous edges. Since discontinuity exists across the segment boundary, any processing utilizing neighboring pixel information should take into account the discontinuity. For example, loop filter can be disabled across the partition boundaries according to an embodiment of the present invention. FIG. 8 illustrates examples of discontinuous boundaries (shown as dashed lines) for layouts 810-842.

In SSP, void data exist around the circular image corresponding to the North Pole and South Pole in order to form a square image. During coding or processing, the pixel data in the void area may need to be accessed. Also, some processing (e.g. filtering or interpolation) may need to access pixel data outside the boundary of the layouts. Accordingly, in one embodiment, padding is applied in the void area between the disk and enclosing square, or around edges and boundaries of the Pole images. For the Pole images, padding can be added using geometry mapping, or extending the boundary value. For the rectangular segment, padding can be added by using geometry mapping, extending the boundary value, or duplicating other sides to the padding region. For example, padding can be applied to the void areas (shown as dots-filled area) for the layouts in FIG. 8.

The padding can be performed before coding. If padding is performed during coding, the padding can be derived from the reconstructed sides of the current or previous frame, or a combination of both.

Mapping Between the Circular Area and Square

There exist some void areas between the circular areas corresponding to the poles and the enclosing square in the SSP format. A method according to the present invention fills the void area by deforming the circular area into a square to avoid any waste of pixel data. There are various known techniques to stretch or deform a circular area into a square. Some examples are shown as follows:

A. Simple Stretching

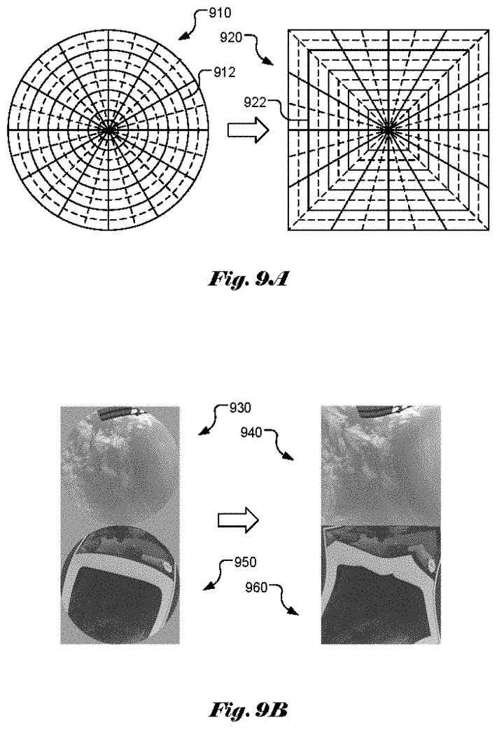

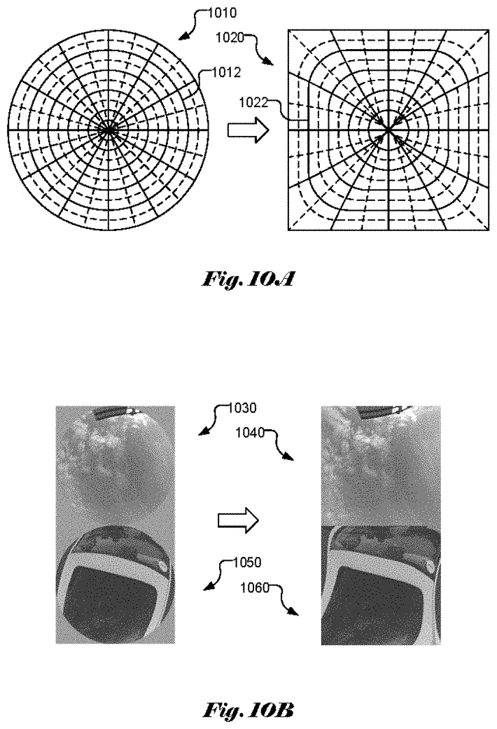

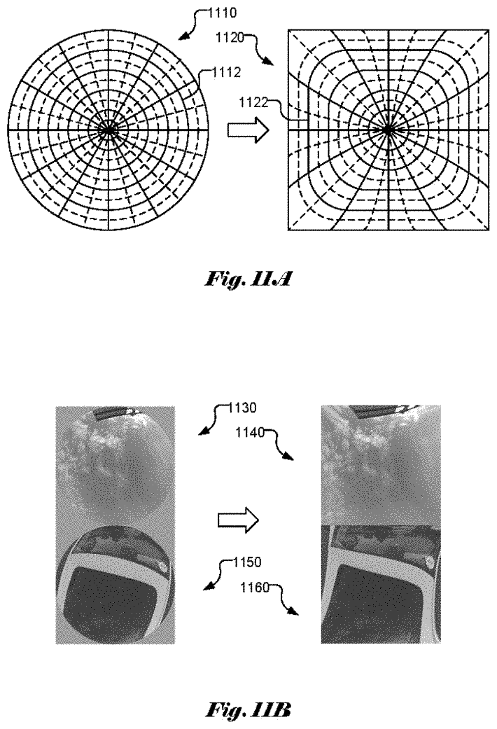

According to the simple stretching, each circle in the circular area 910 is mapped to a square in the square area 920 in FIG. 9A. For example, a target circle 912 is mapped to a target square 922 in FIG. 9A. FIG. 9B illustrates an example of mapping the North Pole image 930 and the South Pole image 950 to square images 940 and 960 respectively. The simple circle to square mapping is according to the following equations:

$$\begin{matrix}x = \{ \begin{matrix}sgn ( u ) \sqrt{{u}^{2} + {v}^{2}} where {u}^{2} \geq {v}^{2} \\ sgn ( v ) \frac{u}{v} \sqrt{{u}^{2} + {v}^{2}} where {u}^{2} < {v}^{2}\end{matrix} , \\ y = \{ \begin{matrix}sgn ( u ) \frac{v}{u} \sqrt{{u}^{2} + {v}^{2}} where {u}^{2} \geq {v}^{2} \\ sgn ( v ) \sqrt{{u}^{2} + {v}^{2}} where {u}^{2} < {v}^{2}\end{matrix} \\ where & ( 13 ) \\ sgn ( x ) = \frac{\vert x \vert}{x} = \{ \begin{matrix}- 1 if x < 0 , \\ 0 if x = 0 , \\ 1 if x > 0\end{matrix} . & ( 14 )\end{matrix}$$

The simple square to circle mapping is according to the following equations:

$$u = \{ \begin{matrix}sgn ( x ) \frac{{x}^{2}}{\sqrt{{x}^{2} + {y}^{2}}} where {x}^{2} \geq {y}^{2} \\ sgn ( y ) \frac{xy}{\sqrt{{x}^{2} + {y}^{2}}} where {x}^{2} < {y}^{2}\end{matrix} , \\ v = \{ \begin{matrix}sgn ( x ) \frac{xy}{\sqrt{{x}^{2} + {y}^{2}}} where {x}^{2} \geq {y}^{2} \\ sgn ( y ) \frac{{y}^{2}}{\sqrt{{x}^{2} + {y}^{2}}} where {x}^{2} < {y}^{2}\end{matrix} . \qquad ( 15 )$$

B. FG-Squircular Mapping

A squircle is a mathematical shape intermediate between a square and a circle developed by Fernandez Guasti. FIG. 10A illustrates an example of mapping a circular area 1010 to a square area 1020 according to FG-squircular mapping. For example, a target circle 1012 is mapped to a target squircle 1022 in FIG. 10A. FIG. 10B illustrates an example of mapping the North Pole image 1030 and the South Pole image 1050 to square images 1040 and 1060 respectively. The FG-squircular mapping is according to the following equations:

$$\begin{matrix}x = \frac{sgn ( uv )}{v \sqrt{2}} \sqrt{{u}^{2} + {v}^{2} - \sqrt{( {u}^{2} + {v}^{2} ) ( {u}^{2} + {v}^{2} - 4 {u}^{2} {v}^{2} )}} & ( 16 ) \\ y = \frac{sgn ( uv )}{u \sqrt{2}} \sqrt{{u}^{2} + {v}^{2} - \sqrt{( {u}^{2} + {v}^{2} ) ( {u}^{2} + {v}^{2} - 4 {u}^{2} {v}^{2} )}} & ( 17 )\end{matrix}$$

The square to circle mapping according to FG-squircular mapping is shown below:

$$u = \frac{x \sqrt{{x}^{2} + {y}^{2} - {x}^{2} {y}^{2}}}{\sqrt{{x}^{2} + {y}^{2}}} , v = \frac{y \sqrt{{x}^{2} + {y}^{2} - {x}^{2} {y}^{2}}}{\sqrt{{x}^{2} + {y}^{2}}} \qquad ( 18 )$$

C. Elliptical Grid Mapping

Elliptical grid mapping is another technique to map between a circular area and a square area. FIG. 11A illustrates an example of mapping a circular area 1110 to a square area 1120 according to Elliptical grid mapping. For example, a target circle 1112 is mapped to a target contour 1122 in FIG. 11A. FIG. 11B illustrates an example of mapping the North Pole image 1130 and the South Pole image 1150 to square images 1140 and 1160 respectively. The Elliptical grid mapping is according to the following equations:

x=½\sqrt{2+u²−v²+2\sqrt{2}u}−½\sqrt{2+u²−v²−2\sqrt{2}u} (19)

x=½\sqrt{2+u²−v²+2\sqrt{2}u}−½\sqrt{2+u²−v²−2\sqrt{2}u} (20)

The square to circle mapping according to Elliptical grid mapping is shown below:

$$u = x \sqrt{1 - \frac{{y}^{2}}{2}} , v = y \sqrt{1 - \frac{{x}^{2}}{2}} \qquad ( 21 )$$

D. Schwarz-Christoffel Mapping

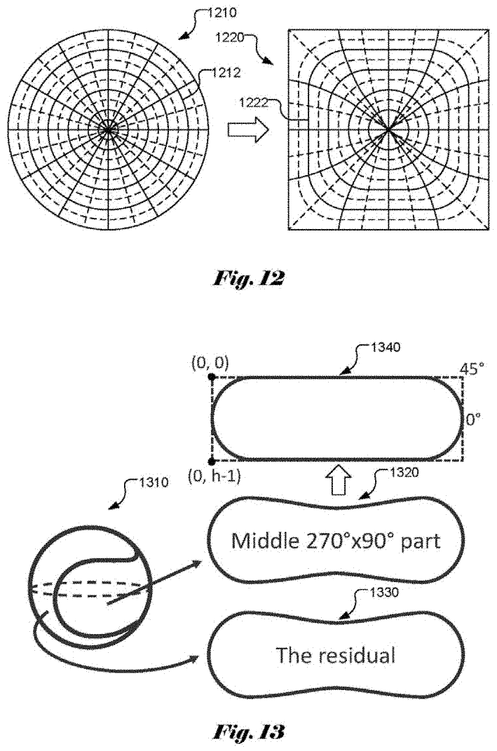

Schwarz-Christoffel mapping is yet another technique to map between a circular area and a square area. FIG. 12 illustrates an example of mapping a circular area 1210 to a square area 1220 according to Schwarz-Christoffel mapping. For example, a target circle 1212 is mapped to a target contour 1222 in FIG. 12A. The Schwarz-Christoffel mapping is according to the following equations:

$$\begin{matrix}x = Re ( \frac{1 - i}{- {K}_{e}} F ( {cos}^{- 1} ( \frac{1 + i}{\sqrt{2}} ( u + vi ) ) , \frac{1}{\sqrt{2}} ) ) + 1 , & ( 22 ) \\ y = Im ( \frac{1 - i}{- {K}_{e}} F ( {cos}^{- 1} ( \frac{1 + i}{\sqrt{2}} ( u + vi ) ) , \frac{1}{\sqrt{2}} ) ) - 1 & ( 23 )\end{matrix}$$

The square to circle mapping according to Schwarz-Christoffel mapping is shown below:

$$\begin{matrix}u = Re ( \frac{1 - i}{\sqrt{2}} cn ( {K}_{e} \frac{1 + i}{\sqrt{2}} ( x + yi ) - {K}_{e} , \frac{1}{\sqrt{2}} ) ) , & ( 24 ) \\ v = Im ( \frac{1 - i}{\sqrt{2}} cn ( {K}_{e} \frac{1 + i}{\sqrt{2}} ( x + yi ) - {K}_{e} , \frac{1}{\sqrt{2}} ) ) & ( 25 )\end{matrix}$$

In the above equations, F(⋅) is the incomplete elliptic integral of the first kind, cn(⋅) is a Jacobi elliptic function, and Kₑ is defined as follows:

$${K}_{e} = {\int }_{0}^{\frac{π}{2}} \frac{dt}{\sqrt{1 - \frac{1}{2} {sin}^{2} t}} \approx 1.854 \qquad ( 26 )$$

In the above, the forward projection from a sphere image to layouts according to segmented sphere project (SSP) is disclosed. The spherical image in the rectangular layout format according to SSP can be further processed, such as compression. When the spherical image is viewed, the spherical image in the rectangular layout format needs to be processed by a reverse process to cover the sphere image. For example, if the two circular images corresponding to the North and South Poles and the rectangular image corresponding to the equatorial segment are available, these images can be used to recover the sphere image. Depending on the particular projection selected for projecting the North Pole region and South Pole region of the sphere into North Pole and South Pole images, a corresponding inverse projection can be used to project the North Pole and South Pole images into the North Pole region and South Pole region of the sphere. Furthermore, if the two Pole images are further mapped into square images using a selected mapping, an inverse mapping can be used to convert the square images back into Pole images. If any padding is applied, the padded data should be removed or ignored during processing.

Rotated Sphere Projection (RSP)

Rotated sphere projection divides the sphere face into two parts: one part represents a 270°×90° region, and the other part represents the residual. The projection format of these two faces can be an equirectangular projection (ERP), or an equal-area projection (EAP), etc. Suppose an RSP face with height h, for a point (x, y) on the face, the latitude φ for the EAP is:

$$ϕ = {sin}^{- 1} ( ( \frac{1}{2} - \frac{y + \frac{1}{2}}{h} \times 2 sin \frac{π}{4} ) \times 2 sin \frac{π}{4} ) \qquad ( 27 )$$

The latitude φ for the ERP is:

$$ϕ = \frac{π}{2} ( \frac{1}{2} - \frac{y + \frac{1}{2}}{h} ) \qquad ( 28 )$$

FIG. 13 illustrates an example of RSP, where the sphere 1310 is partitioned into a middle 270°×90° region 1320, and a residual part 1330. These two parts of RSP can be further stretched on the top side and the bottom side to generate a deformed part 1340 having a horizontal boundary on the top and bottom.

In a more general case, one part of RSP can represent a θ×φ region, and the other part of RSP represents the residual. Suppose an RSP face with height h, for a point (x, y) on the face, the latitude φ′ for the EAP is:

$${ϕ}^{′} = {sin}^{- 1} ( ( \frac{1}{2} - \frac{y + \frac{1}{2}}{h} ) \times 2 sin \frac{ϕ}{2} ) \qquad ( 29 )$$

The latitude φ′ for the ERP is:

$${ϕ}^{′} = ϕ ( \frac{1}{2} - \frac{y + \frac{1}{2}}{h} ) \qquad ( 30 )$$

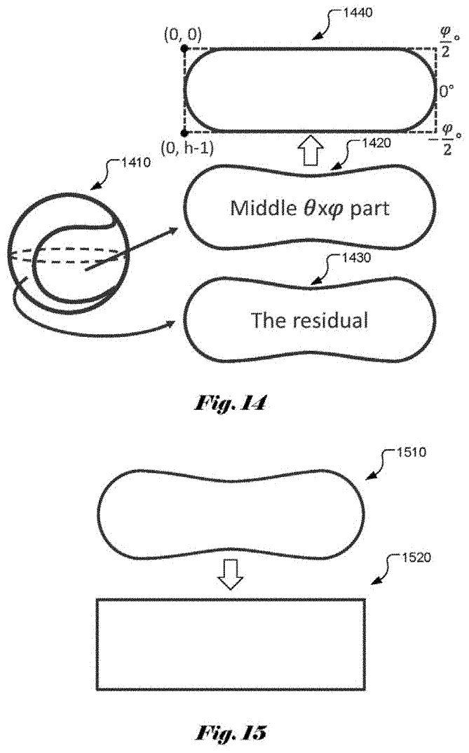

FIG. 14 illustrates an example of RSP where the sphere 1410 is partitioned into a middle θ×φ region 1420, and a residual part 1430. These two parts of RSP can be further stretched on the top side and the bottom side to generate a deformed part 1440 having a horizontal boundary on the top and bottom.

Each of the two-part faces 1510 may also be deformed into a rectangular shape 1520 using various mappings, such as FG-squircular mapping, simple stretching, elliptical grid mapping, or Schwarz-Christoffel mapping, as shown in FIG. 15.

Padding for RSP

There exist some void areas between the original faces and the rectangle enclosing the original faces. Also, some processing may require pixel data from neighboring pixels outside the boundary of the segmented face or the deformed segmented face. According to an embodiment of the present invention, padding can be applied around edges and boundaries of the segmented face or the deformed segmented face. Various padding techniques, such as geometry mapping, spreading the boundary value, or duplicating other sides to the padding region can be used. The padding can be performed before coding. If padding is performed during coding, the padding may use data from the reconstructed part of the current or from a previous frame, or a combination of both.

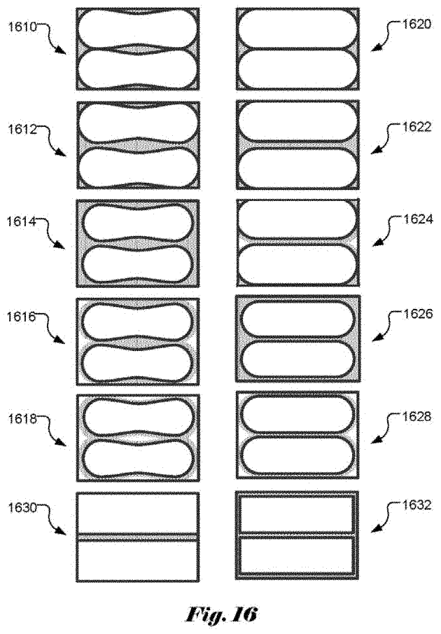

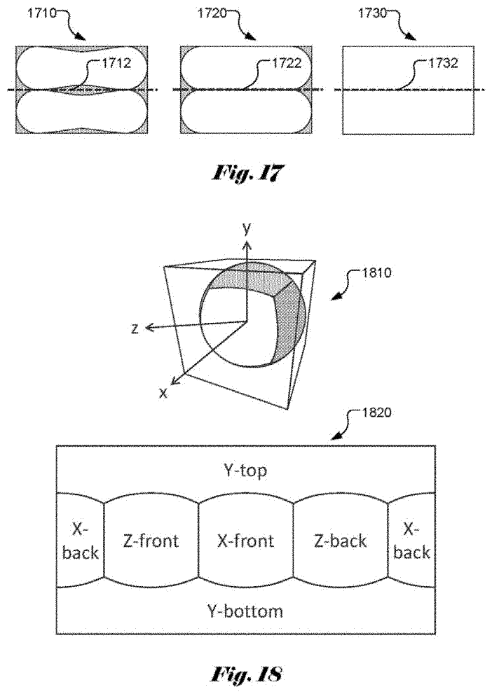

FIG. 16 illustrates examples of padding of original segmented faces and modified segmented faces for different layouts. For examples, blocks 1610 to 1618 represent padding for various layouts related to original segmented faces, where the dots-filled area indicate padded areas. Blocks 1620 to 1628 represent padding for various layouts related to modified segmented faces to have horizontal boundaries, where the dots-filled area indicate padded areas. Blocks 1630 to 1632 represent padding for various layouts related to modified segmented faces to form rectangular areas, where the dots-filled area indicate padded areas.

Partitioning the RSP

The picture resulted from RSP can be divided into partitions such as slices, tiles, etc., according to the discontinuous edges. Some processing using neighboring pixel data may cause artifact across discontinuous edges. Therefore, according to an embodiment of the present invention, processing using neighboring pixel data, such as loop filtering, can be disabled across partition boundaries.

FIG. 17 illustrates examples of partition boundaries for RSP and modified RSP layouts, where boundary 1712 is associated with the RSP layout 1710, boundary 1722 is associated with the modified RSP layout 1720 with top side and bottom side deformed to become horizontal edges, and boundary 1732 is associated with the modified RSP layout 1730 by stretching the face into a rectangular area.

In the above, the forward projection from a sphere image to layouts according to rotated sphere project (RSP) is disclosed. The spherical image in the rectangular layout format according to RSP can be further processed, such as compression. When the spherical image is viewed, the spherical image in the rectangular layout format needs to be processed by a reverse process to cover the sphere image. For example, if the first part and the second part of RSP are available, the two parts can be used to recover the sphere image. Furthermore, if the two parts of RSP are in a deformed format, such as the deformed part 1440 in FIG. 14, an inverse projection can be applied to recover the original two parts of RSP. If the two parts of RSP are stretched into a rectangular image, an inverse projection can be applied to convert the rectangular parts to original parts of RSP. If any padding is applied, the padded data should be removed or ignored during processing.

Modified Cubemap Projection

A cubemap projection consists of six square faces, which divide the surface of the sphere equally. However, the angles on each face may not equally separate. FIG. 18 illustrates an example of the cubemap projection, where the coordinates of a sphere 1810 is shown. An ERP image 1820 for the cubemap projection consists of X-front, X-back, Z-front, Z-back, Y-top and Y-bottom.

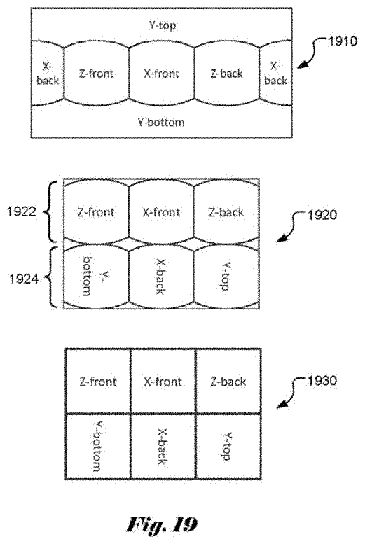

According to one embodiment, the six faces 1910 are divided to two groups 1920, and each group has three continuous faces as shown in FIG. 19. For example, the first group 1922 consists of face z-front, x-front, and z-back while the other group 1924 consists of face y-top, x-back, and y-bottom. According to another embodiment, each of the modified groups (i.e., 1922 and 1924) can be further resampled to a rectangle by dividing the latitude direction and the longitude direction equally. These two further modified groups can then be combined to a rectangle layout 1930 as shown in FIG. 19.

Padding for Modified Cubemap Projection

There exist some void areas between the original faces and the rectangle enclosing the original faces. Also, some processing may require pixel data from neighboring pixels outside the boundary of the segmented face or the deformed segmented face. According to an embodiment of the present invention, padding can be applied around edges and boundaries of the segmented face or the deformed segmented face. Various padding techniques, such as geometry mapping, spreading the boundary value, or duplicating other sides to the padding region can be used. The padding can be performed before coding. If padding is performed during coding, the padding may use data from the reconstructed part of the current or from a previous frame, or a combination of both.

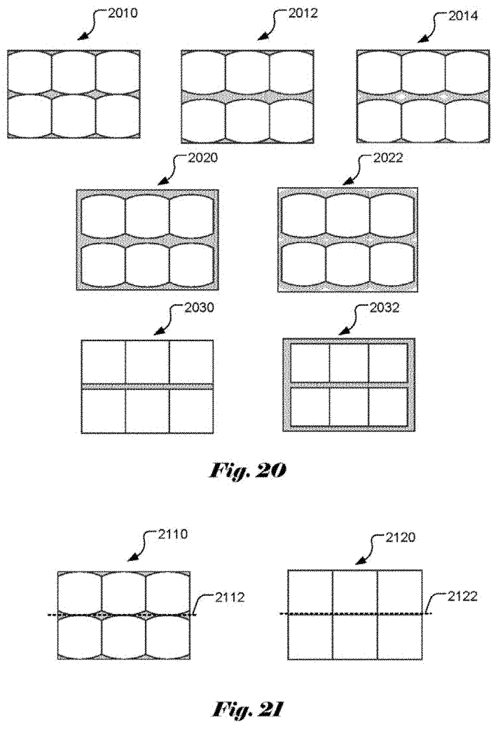

FIG. 20 illustrates examples of padding of two-group faces and modified two-group faces for different layouts. For examples, blocks 2010 to 2014 represent padding for various layouts related to two-group faces, where the dots-filled area indicate padded areas. Blocks 2020 to 2022 represent padding for various layouts related to modified two-group faces, where the padding extends beyond the two-group faces as indicated by the dots-filled area. Blocks 2030 to 2032 represent padding for various layouts related to modified two-group faces to form rectangular areas, where the dots-filled area indicate padded areas.

Partitioning the Modified Cubemap Projection

The picture resulted from modified cubemap projection can be divided into partitions such as slices, tiles, etc., according to the discontinuous edges. Some processing using neighboring pixel data may cause artifact across discontinuous edges. Therefore, according to an embodiment of the present invention, processing using neighboring pixel data, such as loop filtering, can be disabled across partition boundaries.

FIG. 21 illustrates examples of partition boundary for two-group faces and modified two-group faces, where boundary 2112 is associated with the two-group face layout 2110, and boundary 2122 is associated with the modified two-group faces layout 2120 with the faces deformed into a rectangular areas.

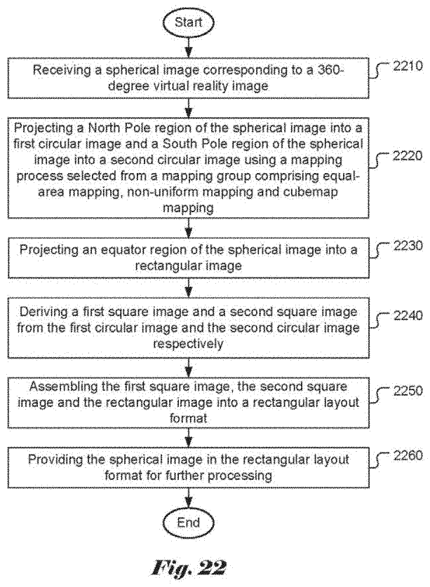

FIG. 22 illustrates an exemplary flowchart of a system that processes spherical images related to segmented sphere projection (SSP) according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, a spherical image corresponding to a 360-degree virtual reality image is received in step 2210. A North Pole region of the spherical image is projected into a first circular image and a South Pole region of the spherical image is projected into a second circular image using a mapping process selected from a mapping group comprising equal-area mapping, non-uniform mapping and cubemap mapping in step 2220. An equator region of the spherical image is projected into a rectangular image in step 2230. A first square image and a second square image are derived from the first circular image and the second circular image respectively in step 2240. The first square image, the second square image and the rectangular image are assembled into a rectangular layout format in step 2250. The spherical image in the rectangular layout format is then provided for further processing in step 2260.

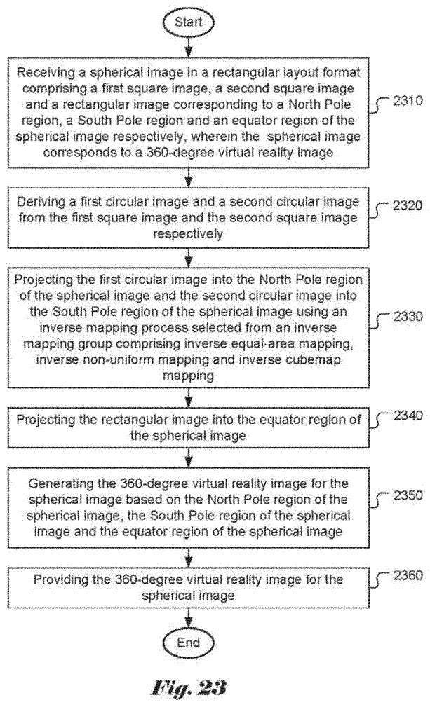

FIG. 23 illustrates an exemplary flowchart of a system that processes spherical images related to inverse segmented sphere projection (SSP) according to an embodiment of the present invention. A spherical image in a rectangular layout format comprising a first square image, a second square image and a rectangular image corresponding to a North Pole region, a South Pole region and an equator region of the spherical image respectively is received in step 2310, where the spherical image corresponds to a 360-degree virtual reality image. A first circular image and a second circular image are derived from the first square image and the second square image respectively in step 2320. The first circular image is projected into the North Pole region of the spherical image and the second circular image is projected into the South Pole region of the spherical image using an inverse mapping process selected from an inverse mapping group comprising inverse equal-area mapping, inverse non-uniform mapping and inverse cubemap mapping in step 2330. The rectangular image is projected into the equator region of the spherical image in step 2340. The 360-degree virtual reality image is generated for the spherical image based on the North Pole region of the spherical image, the South Pole region of the spherical image and the equator region of the spherical image in step 2350. The 360-degree virtual reality image is provided for the spherical image in step 2360.

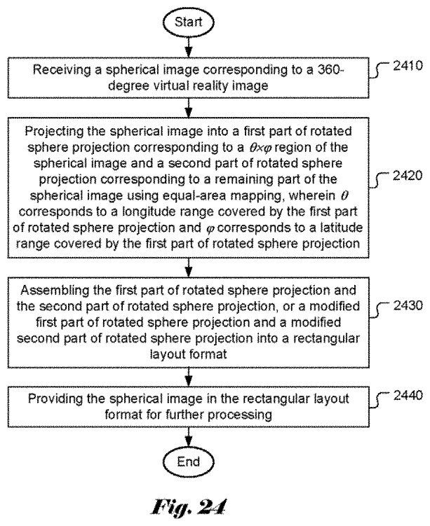

FIG. 24 illustrates an exemplary flowchart of a system that processes spherical images related to rotated sphere projection (RSP) according to an embodiment of the present invention. According to this method, a spherical image corresponding to a 360-degree virtual reality image is received in step 2410. The spherical image is projected into a first part of rotated sphere projection corresponding to a θ×φ region of the spherical image and a second part of rotated sphere projection corresponding to a remaining part of the spherical image using equal-area mapping in step 2420, where B corresponds to a longitude range covered by the first part of rotated sphere projection and φ corresponds to a latitude range covered by the first part of rotated sphere projection. The first part of rotated sphere projection and the second part of rotated sphere projection, or a modified first part of rotated sphere projection and a modified second part of rotated sphere projection are assembled into a rectangular layout format in step 2430. The spherical image in the rectangular layout format is provided for further processing in step 2440.

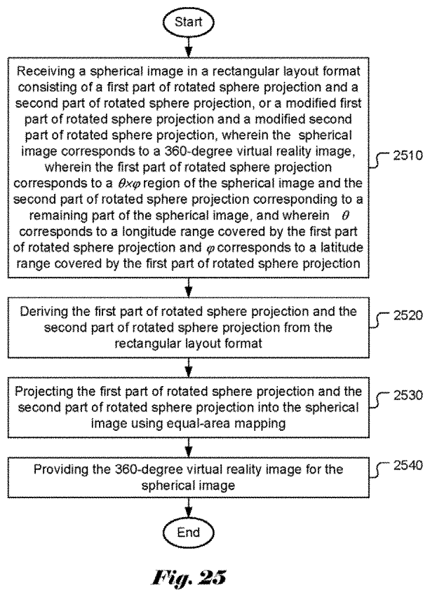

FIG. 25 illustrates an exemplary flowchart of a system that processes spherical images related to inverse rotated sphere projection (RSP) according to an embodiment of the present invention. According to this method, a spherical image in a rectangular layout format consisting of a first part of rotated sphere projection and a second part of rotated sphere projection, or a modified first part of rotated sphere projection and a modified second part of rotated sphere projection are received in step 2510, where the spherical image corresponds to a 360-degree virtual reality image, the first part of rotated sphere projection corresponds to a θ×φ region of the spherical image and the second part of rotated sphere projection corresponding to a remaining part of the spherical image, and B corresponds to a longitude range covered by the first part of rotated sphere projection and φ corresponds to a latitude range covered by the first part of rotated sphere projection. The first part of rotated sphere projection and the second part of rotated sphere projection are derived from the rectangular layout format in step 2520. The first part of rotated sphere projection and the second part of rotated sphere projection are projected into the spherical image using equal-area mapping in step 2530. The 360-degree virtual reality image is provided for the spherical image in step 2540.

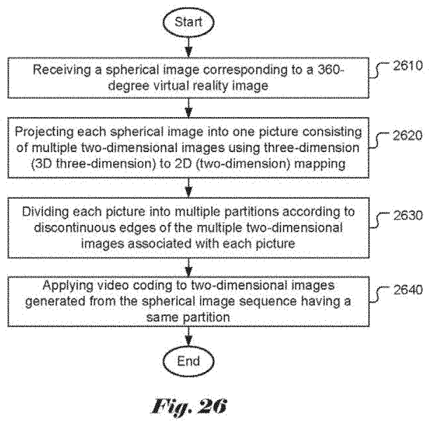

FIG. 26 illustrates an exemplary flowchart of a system that processes spherical images by projecting each spherical image into one two-dimensional picture using 3D (three-dimension) to 2D (two-dimension) mapping according to an embodiment of the present invention, where each picture is divided into multiple partitions according to discontinuous edges. According to this method, a spherical image sequence is received in step 2610, wherein each spherical image corresponds to one 360-degree virtual reality image. Each spherical image is projected into one picture consisting of multiple two-dimensional images using three-dimension (3D three-dimension) to 2D (two-dimension) mapping in step 2620. Each picture is divided into multiple partitions according to discontinuous edges of the multiple two-dimensional images associated with each picture in step 2630. Video coding is applied to two-dimensional images generated from the spherical image sequence having a same partition in step 2640.

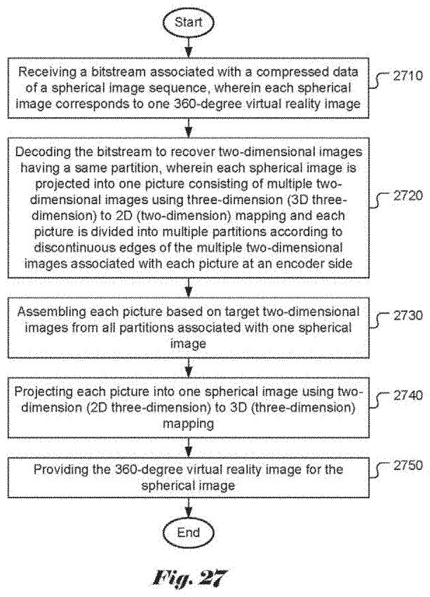

FIG. 27 illustrates an exemplary flowchart of a system that processes spherical images by projecting each two-dimensional picture into one spherical image using 2D (two-dimension) to 3D (three-dimension) mapping according to an embodiment of the present invention, where each picture is divided into multiple partitions according to discontinuous edges. According to this method, a bitstream associated with a compressed data of a spherical image sequence is received in step 2710, where each spherical image corresponds to one 360-degree virtual reality image. The bitstream is decoded to recover two-dimensional images having a same partition in step 2720, where each spherical image is projected into one picture consisting of multiple two-dimensional images using three-dimension (3D three-dimension) to 2D (two-dimension) mapping and each picture is divided into multiple partitions according to discontinuous edges of the multiple two-dimensional images associated with each picture at an encoder side. Each picture is assembled based on target two-dimensional images from all partitions associated with one spherical image in step 2730. Each picture is projected into one spherical image using two-dimension (2D three-dimension) to 3D (three-dimension) mapping in step 2740. One 360-degree virtual reality image is provided for each spherical image in step 2750.

The flowchart shown above is intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing spherical images, the method comprising:
receiving a spherical image corresponding to a 360-degree virtual reality image;
projecting a North Pole region of the spherical image into a first circular image and a South Pole region of the spherical image into a second circular image using a mapping process selected from a mapping group comprising equal-area mapping, non-uniform mapping and cubemap mapping;
projecting an equator region of the spherical image into a rectangular image;
deriving a first square image and a second square image from the first circular image and the second circular image respectively;
assembling the first square image, the second square image and the rectangular image into a rectangular layout format; and
providing the spherical image in the rectangular layout format for further processing.

2. The method of claim 1, wherein the first circular image and the second circular image are projected into the first square image and the second square image respectively using FG-Squircular mapping, simple stretching, elliptical grid mapping or Schwarz-Christoffel mapping.

3. The method of claim 1, wherein the rectangular layout format corresponds to the first square image and the second square image on separate ends of the rectangular image placed in a horizontal direction, the first square image and the second square image on separate ends of the rectangular image placed in a vertical direction, the first square image and the second square image stacked vertically with the rectangular image distorted and butted in a horizontal direction, or the first square image and the second square image stacked horizontally with the rectangular image distorted and butted in a vertical direction.

4. The method of claim 1, wherein data padding is applied to any void area between the first circular image and a first enclosing square, between the second circular image and a second enclosing square, or between both the first circular image and the second circular image and a third enclosing rectangle.

5. A method of processing spherical images, the method comprising:
receiving a spherical image corresponding to a 360-degree virtual reality image;
projecting the spherical image into a first part of rotated sphere projection corresponding to a θ×φ region of the spherical image and a second part of rotated sphere projection corresponding to a remaining part of the spherical image using equal-area mapping, wherein θ corresponds to a longitude range covered by the first part of rotated sphere projection and co corresponds to a latitude range covered by the first part of rotated sphere projection;
assembling the first part of rotated sphere projection and the second part of rotated sphere projection, or a modified first part of rotated sphere projection and a modified second part of rotated sphere projection into a rectangular layout format; and
providing the spherical image in the rectangular layout format for further processing.

6. The method of claim 5, wherein the modified first part of rotated sphere projection is generated by stretching a top side and a bottom side of the first part of rotated sphere projection to form horizontal boundaries on the top side and the bottom side of the modified first part of rotated sphere projection and the modified second part of rotated sphere projection is generated by stretching a top side and a bottom side of the second part of rotated sphere projection to form horizontal boundaries on the top side and the bottom side of the modified second part of rotated sphere projection.

7. The method of claim 5, wherein the modified first part of rotated sphere projection is generated by applying projection to map the first part of rotated sphere projection into a first rectangular area and the modified second part of rotated sphere projection is generated by applying projection to map the second part of rotated sphere projection into a second rectangular area, wherein the projection is selected from a mapping group comprising FG-squircular mapping, simple stretching, elliptical grid mapping, Schwarz-Christoffelmapping.

8. The method of claim 7, wherein padding is applied around edge or boundary of the first part of rotated sphere projection, the modified first part of rotated sphere projection, the second part of rotated sphere projection, the modified second part of rotated sphere projection or the rectangular layout format.

9. The method of claim 8, wherein said padding is selected from a padding group comprising geometry mapping, spreading a boundary value and duplicating other sides to a padding region.

10. A method of processing spherical images, the method comprising:
receiving a spherical image sequence, wherein each spherical image corresponds to one 360-degree virtual reality image;
projecting each spherical image into one picture consisting of multiple two-dimensional images using three-dimension (3D three-dimension) to 2D (two-dimension) mapping;
dividing each picture into multiple partitions according to discontinuous edges of the multiple two-dimensional images associated with each picture; and
applying video coding to two-dimensional images generated from the spherical image sequence having a same partition.

11. The method of claim 10, wherein the three-dimension (3D three-dimension) to 2D (two-dimension) mapping is selected from a group comprising segmented sphere projection (SSP), rotated sphere projection (RSP) and cubemap projection (CMP).

12. The method of claim 10, wherein each partition corresponds to one partitioned into one slice or one tile.

13. The method of claim 10, wherein a loop-filter process related to the video coding is disabled across any partition boundary.
